(19) United States
(12) Patent Application Publication
(10) Pub. No.: US 2024/0232985 A1
(43) Pub. Date: Jul. 11, 2024

(54) Automatically Populating Shopping Cart from Electronic Shopping List

(71) Applicant: Cabaire, LLC, Edmond, OK (US)

(72) Inventor: Alex Ruhter, Edmond, OK (US)

(21) Appl. No.: 18/392,565

(22) Filed: Dec. 21, 2023

Related U.S. Application Data
(60) Provisional application No. 63/478,859, filed on Jan. 6, 2023.

(51) Int. Cl. G06Q 30/0601

(52) U.S. Cl. CPC G06Q 30/0633; G06Q 30/0643

(57) ABSTRACT

An automatically populating electronic shopping cart for a pickup only grocery store. The electronic shopping cart may be automatically populated from an electronic shopping list. A user interface is provided that enables freeform text entry into a text field. The text entries may correspond to items in an electronic shopping list associated with the pickup only grocery store. After submission of the text entries, an electronic shopping cart may be automatically populated with available inventory items from the pickup only grocery store based on the items in the electronic shopping list.

### CROSS-REFERENCE TO RELATED APPLICATIONS

This application claims priority from U.S. Provisional Application No. 63/478,859 filed Jan. 6, 2023, and titled “AUTOMATICALLY POPULATING SHOPPING CART FROM ELECTRONIC SHOPPING LIST.” For purposes of United States patent practice, this application incorporates the contents of the Provisional Application by reference in its entirety.

### BACKGROUND

### Field of the Disclosure

The present disclosure generally relates to shopping lists and user interfaces for a pickup only grocery store. More specifically, embodiments of the disclosure relate to an automatically populating shopping list of items for a consumer using a pickup only grocery store.

### Description of the Related Art

The use of a shopping list for items such as groceries have become almost universal. Consumers often use physical or electronic shopping lists to prepare a list of items for purchase at a grocery store. Such lists are often prepared before arrival at the store, and often include recurring items (that is, items that are repurchases at regular or irregular intervals).

However, such lists are divorced from the in-stock inventory of the grocery store, and a consumer may find that one or more items are out of stock. Moreover, brand names for desired items and item types may differ between grocery stores and may not match the available inventory at a particular store.

### SUMMARY

Grocery stores and other stores have recently offered delivery and pickup options. For example, a consumer may submit an order online, via a website or smartphone application, and drive to the store to pickup the order. However, such stores remain open to consumers to shop in-person. Consequently, inventory management, order fulfillment, delivery, and pickup, are complicated by the different consumer uses and remain unoptimized for a particular order type. These problems extend to the shopping lists used by the consumer, as the shopping lists do not match the unoptimized inventory of a store. Moreover, these generalized shopping lists are inefficient for a specific order type and are not optimized for use with a pickup order type.

Although some grocery stores offer online ordering and purchase, the use of this functionality often takes more time than physically shopping at the store in-person. Existing online ordering and purchasing systems do not work efficiently with shopping lists and often require extra time-consuming steps when compared to shopping at the store in-person.

Embodiments of the disclosure generally relate to an automatically populating shopping cart for a pickup only grocery store (that is, a grocery store that does not allow customers to enter and shop inside the store). The pickup only grocery store offers a pick-only order type and may include an optimized inventory and order fulfillment systems that enable streamlined pickup of groceries from the automatically populating shopping cart.

In one embodiment, a computer-implemented method is provided. The method includes providing in an application on a user device, by a processor, a text entry field for freeform text entry of a shopping list associated with a grocery store and receiving, by the processor, a submission of text entered in the text entry field, the text corresponding to a one or more items of the shopping list, and a respective quantity for each of the one or more items. The method further includes processing, by the processor, the text to identify one or more specific inventory items in the grocery store that correspond to the respective one or more items of the shopping list and providing, in the application on the user device, by the processor, a shopping cart that includes the one or more specific inventory items, respective quantities for each or the one or more specific inventory items, and respective prices for each or the one or more specific inventory items, such that each of the one or more inventory items replaces the respective one or more items of the shopping list.

In some embodiments, the shopping cart includes a total price having a sum of the respective prices for each or the one or more specific inventory. In some embodiments, the shopping cart includes a user interface element for submission of an order based on the shopping cart. In some embodiments, the method includes receiving, by the processor, a selection of the user interface element for submission of an order based on the shopping cart and submitting, via a network, an order to the grocery store, the order having the one or more inventory items. In some embodiments, the method includes providing, in the application on the user device, by a processor, a user interface element indicating that the one or more items of the shopping list were added to the shopping cart.

In another embodiment, a non-transitory computer-readable medium having executable computer code stored thereon is provided. The executable computer code having instructions that, when executed, cause a processor to perform operations that include providing in an application on a user device, by the processor, a text entry field for freeform text entry of a shopping list associated with a grocery store and receiving, by the processor, a submission of text entered in the text entry field, the text corresponding to a one or more items of the shopping list, and a respective quantity for each of the one or more items. The operations further include processing, by the processor, the text to identify one or more specific inventory items in the grocery store that correspond to the respective one or more items of the shopping list and providing, in the application on the user device, by the processor, a shopping cart that includes the one or more specific inventory items, respective quantities for each or the one or more specific inventory items, and respective prices for each or the one or more specific inventory items, such that each of the one or more inventory items replaces the respective one or more items of the shopping list.

In some embodiments, the shopping cart includes a total price having a sum of the respective prices for each or the one or more specific inventory. In some embodiments, the shopping cart includes a user interface element for submission of an order based on the shopping cart. In some embodiments, the operations include receiving, by the processor, a selection of the user interface element for submission of an order based on the shopping cart and submitting, via a network, an order to the grocery store, the order includes the one or more inventory items. In some embodiments, the operations include providing, in the application on the user device, by a processor, a user interface element indicating that the one or more items of the shopping list were added to the shopping cart.

In another embodiment, a system is provided that includes a processor and non-transitory computer-readable memory communicatively coupled to the processor and having executable computer code stored thereon. The executable computer code includes instructions that, when executed, cause one or more processors to perform the operations that include providing in an application on a user device, by the processor, a text entry field for freeform text entry of a shopping list associated with a grocery store and receiving, by the processor, a submission of text entered in the text entry field, the text corresponding to a one or more items of the shopping list, and a respective quantity for each of the one or more items. The operations further include processing, by the processor, the text to identify one or more specific inventory items in the grocery store that correspond to the respective one or more items of the shopping list and providing, in the application on the user device, by the processor, a shopping cart that includes the one or more specific inventory items, respective quantities for each or the one or more specific inventory items, and respective prices for each or the one or more specific inventory items, such that each of the one or more inventory items replaces the respective one or more items of the shopping list.

In some embodiments, the shopping cart includes a total price having a sum of the respective prices for each or the one or more specific inventory. In some embodiments, the shopping cart includes a user interface element for submission of an order based on the shopping cart. In some embodiments, the operations include receiving, by the processor, a selection of the user interface element for submission of an order based on the shopping cart and submitting, via a network, an order to the grocery store, the order includes the one or more inventory items. In some embodiments, the operations include providing, in the application on the user device, by a processor, a user interface element indicating that the one or more items of the shopping list were added to the shopping cart.

### BRIEF DESCRIPTION OF THE DRAWINGS

FIG. 1 is a block diagram of a pickup only grocery store system for use with the automatically populating shopping cart in accordance with an embodiment of the disclosure;

FIGS. 2A-2C are schematic diagrams that depict screens of a user interface illustrating an electronic shopping list associated with an automatically populating shopping cart in accordance with an embodiment of the disclosure;

FIG. 3 is a schematic diagram that depicts a screen of a user interface illustrating an automatically populating shopping cart in accordance with an embodiment of the disclosure; and

FIG. 4 is a block diagram of a computer in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure include systems, methods, and computer-readable media for an electronic shopping cart associated with a pickup only grocery store and that is automatically populated from an electronic shopping list. A user interface is provided that enables freeform text entry into a text field. The text entries may correspond to items in an electronic shopping list associated with the pickup only grocery store. After submission of the text entries, a shopping cart may be automatically populated with available inventory items from the pickup only grocery store based on the items in the electronic shopping list.. The shopping list may be submitted to an order fulfillment system of the pickup only grocery store so a user may pickup the order at a designated time or time window.

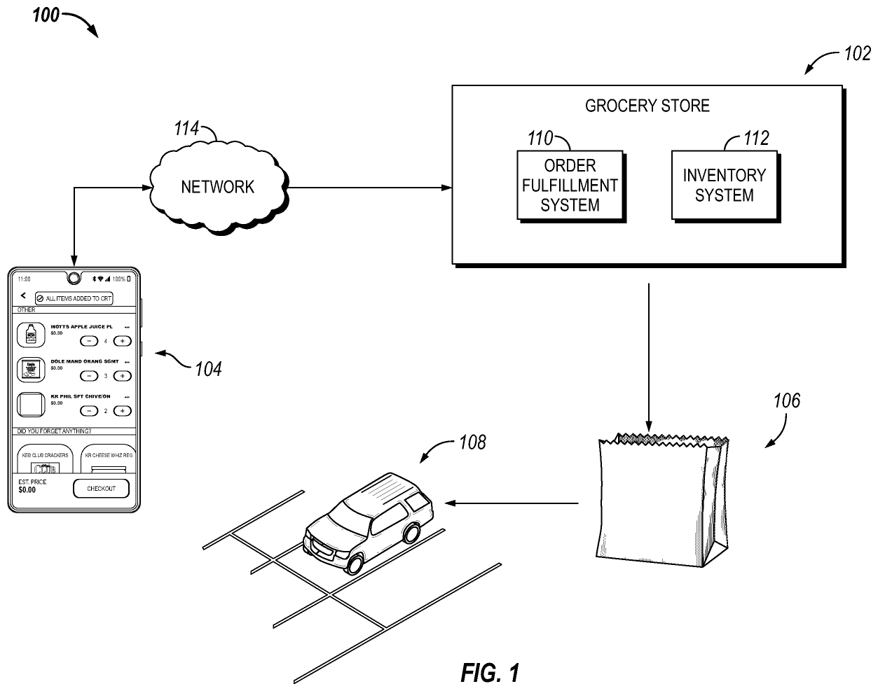

FIG. 1 is a block diagram of a system 100 for implementing embodiments of the disclosure. FIG. 1 depicts a pickup only grocery store 102 that receives orders from a user device 104 via an electronic shopping cart. After receiving an order from the user device 104, the pickup only grocery store fulfills an order 106 for pickup by selecting the items and placing them in containers (e.g., bags). A shown in 108, user may arrive at the grocery store in a vehicle at a designated time or time window to pickup the order.

The user device 104 may be a smartphone, tablet, or other hand-held networked computing device having a display, a user input device (e.g., buttons, keys, voice recognition, or a single or multi-touch touchscreen), memory (e.g., a machine-readable non-transitory memory), a network interface, a portable energy source (e.g., a battery), and a processor (which, as used herein, includes one or more processors) coupled to each of these components. The memory of the user device 104 may store instructions that when executed by the associated processor provide an operating system and various applications, including a web browser or a native mobile application. The native application, in some embodiments, is operative to provide a user interface that communicates with a order fulfillment system of the grocery store and facilitates user interaction with data from the grocery store. The native application and the web browser, upon rendering a webpage, may generally be referred to as client applications of the order fulfillment system, which in some embodiments may be referred to as a server. Embodiments, however, are not limited to client/server architectures, and the order fulfillment system may include a variety of components other than those functioning primarily as a server.

In some embodiments, the user device 104 may be a desktop computer or laptop that may also include a web browser that serves the same or similar role as the native application or web browser in the mobile user device. In addition, the desktop computer or laptop may include a monitor, a keyboard, a mouse, memory, a processor (which, as used herein, encompasses use of one or more processors), and a non-transitory, machine-readable memory storing instructions that when executed by the processor provide an operating system and the web browser.

The pickup only grocery store 102 may include, for example, an order fulfillment system 110 and an inventory system 112. The order fulfillment system 110 may receive orders from a user device 104 over a network 114 by way of a submitted electronic shopping cart. The order fulfillment system may communicate with the inventory system 112 to fulfill an order based on available inventory items in the grocery store 112. The order fulfillment system 110 may include, in some embodiments, a plurality of records, each record being a user profile and having a user identifier, a user purchase history, user preferences, offers or other promotions, account information (e.g. user credentials), a location of the user device or the user, or other information. The inventory system 112 may store a real-time inventory of items in the pickup only grocery store 102 and may facilitate relatively efficient and fast fulfillment of orders as compared to conventional grocery stores that provide for customer entry into the store.

The user device 104 may execute a native application (provided by the pickup only grocery store 102 for interaction with the order fulfillment system 110. For example, an application may be downloaded and installed via an “app store” or otherwise obtained. In some embodiments, the application may be a website executed within a web browser executing on the user device.

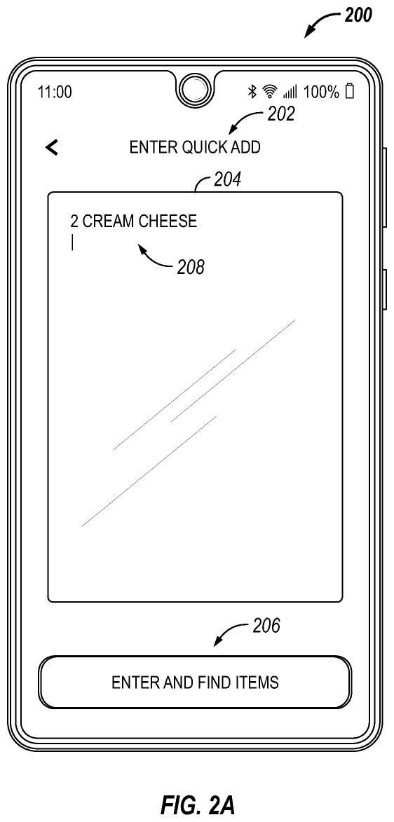

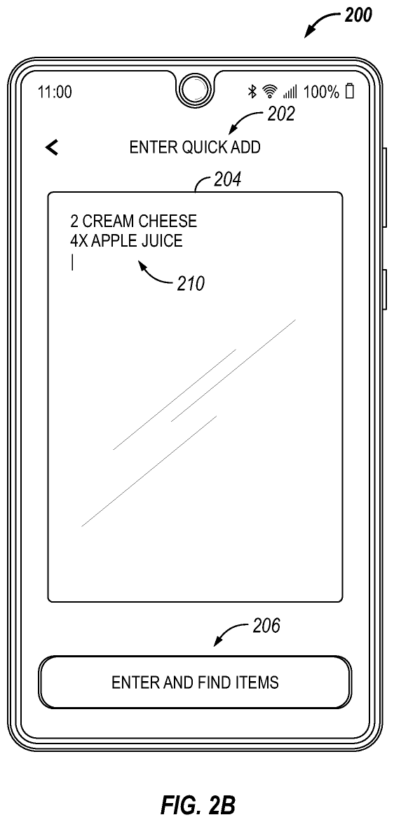

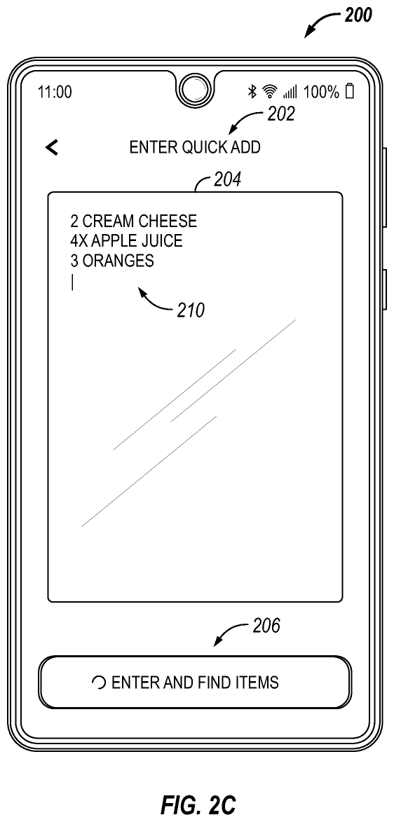

By way of example, FIGS. 2A-2C are schematic diagrams of screens of a user interface for an automatically populating shopping cart based on a shopping list in accordance with an embodiment of the disclosure. The user interface screens may be provided in a native application associated with a pickup only grocery store and executed on a mobile user device.

FIG. 2A depicts a first screen 200 that includes a title (“Enter Quick Add”) 202, a text entry field 204, and a selectable element (e.g., button 206 labeled “Enter and Find Items”). The title 205 may identify the section of the user interface currently displayed and associated functionality in use for the user. In the embodiment shown in FIGS. 2A-2C, embodiments of the disclosure are implemented via a “Quick Add” feature accessed via another screen of the user interface.

The text entry field 206 may allow for freeform text entry by a user via a text input mechanism provided on the user device. For example, the text may be input via a keyboard or speech-to-text functionality provide in a native application of the operating system of the user device. FIG. 2A depicts a first text entry 208 entered by a user into the text entry field 206. The first text entry 208 corresponds to an item in a user's shopping list. In the embodiment shown in FIG. 2A, first text entry 208 includes a quantity (“2”) and generic name (“cream cheese.”). In some embodiments, a carriage return may be used as a delimiter between the items of a shopping list entered in the text entry field 206. In other embodiments, alternative or additional delimiters may be used.

By way of example in FIGS. 2A-2C, a carriage return may be entered to proceed to the next line corresponding to the next item in the shopping list. For example, FIG. 2B depicts a second text entry 210 entered by a user into the text entry field 206. In the embodiment shown in FIG. 2A, second text entry 208 includes a quantity (“4×”) and generic name (“apple juice”). In another example, FIG. 2C depicts a third text entry 212 entered by a user into the text entry field 206, separated from the second text entry 208 by a carriage return. In the embodiment shown in FIG. 2A, the second text entry 212 includes a quantity (“3”) and generic name (“oranges”). In some embodiments, a carriage return may be used as a delimiter between the items of a shopping list entered in the text entry field 210. In other embodiments, alternative or additional delimiters may be used. Additionally, embodiments may not require a specific arrangement of name and quantity. For example, although FIGS. 2A-2C depict a quantity that precedes a generic name, a user may enter a generic name followed by a quantity which would also be processed in the manner described in the disclosure.

When a user is finished entering text into the text entry field 204, the selectable button 206 may be selected to submit the shopping list items and associated quantities for auto-population into a shopping cart. As discussed in the disclosure, each item in the shopping list entered into the text entry field 204 may be replaced with a available inventory item (that is, an item that is in-stock and available for immediate purchase at the pickup only grocery store associated with the user interface).

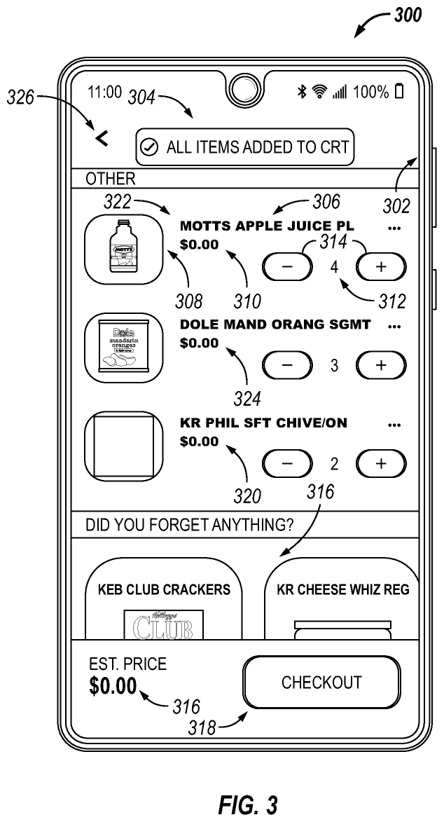

FIG. 3 is a schematic diagram of a screen 300 of a user interface that depicts the shopping cart automatically generated from the generic items illustrated above in FIGS. 2A-2C. The user interface screen 300 includes a list 302 of items in the shopping cart and a confirmation indicator 304 that the items from the “Quick Add” list were added. Each item may include a name 306, a picture 308, a price 310, and a quantity 312 with user selectable elements (e.g., buttons 314) for increasing or decreasing the quantity. The screen may include additional user selectable elements 316 for adding suggested or previously purchased items to the shopping cart.

As also shown in FIG. 3, the user interface screen 300 includes the total price 316 of the items in the cart, and a “Checkout” user selectable element (e.g., a button 318). For each item from the “Quick Add” list, the shopping cart in the screen 300 includes a quantity corresponding to the quantity entered by the user and an available inventory item corresponding to the generic item entered by the user. For example, the first item entered as shown in FIG. 2A is automatically added to the user's shopping cart as item 320: “KR PHIL SFT CHIVE/ON” with a quantity of 2. The second item entered as shown in FIG. 2B is added to the user's shopping cart as item 322: “MOTTS APPLE JUICE PL” with a quantity of 4. The third item entered as shown in FIG. 2C is added to the user's shopping cart as item 324: “DOLE MAND ORANG SGMT” with a quantity of 3. In this manner, the shopping list items entered via text entry are replaced with available inventory items from the pickup only grocery store in a ready-for-submission shopping cart.

The matching of a text entry from the “Quick Add” list to a specific inventory item for the shopping cart may occur via suitable string-parsing and text-matching techniques. Such techniques may include natural language processing (NLP), word cloud, rule-based matching, machine learning, or other techniques. The matching may include interfacing with an order fulfillment system of a pickup only grocery store so that real-time inventory is used to identify a suitable item for the shopping cart.

In some embodiments, multiple available inventory items may match a text item from a user's shopping list. In such embodiments, a specific inventory item may be selected based on one or more weighted or unweighted criteria. Such criteria may include user purchase history, user preferences (for example dietary preferences or brand preferences), current inventory, or other criteria.

As shown in FIG. 3, the user interface screen 300 enables a user to select (e.g., touch or click) the user-selectable “Checkout” button 318 to submit the shopping cart and place an order. Alternatively, a user may return to the previous screen (i.e., the “Quick Add” screen depicted in FIGS. 2-4) by selection of a user-selectable element (e.g., back button 326) to continue adding to a shopping list.

The indicator 304 may indicate that all items from the “Quick Add” text entry shown in screens FIG. 2A-2C have been added to the shopping cart, such as by the text “All items added to cart” shown in FIG. 3. In some embodiments, the indicator 304 may include text indicating that some items from the “Quick Add” function were not added to the shopping cart. For example, in some embodiments, one or more items from the text entries may be unable to be matched to a specific inventory item. In such embodiments, the indicator 304 may provide a user-selectable element that enables a user to access another screen to select substitutes or delete items from a shopping list or shopping cart.

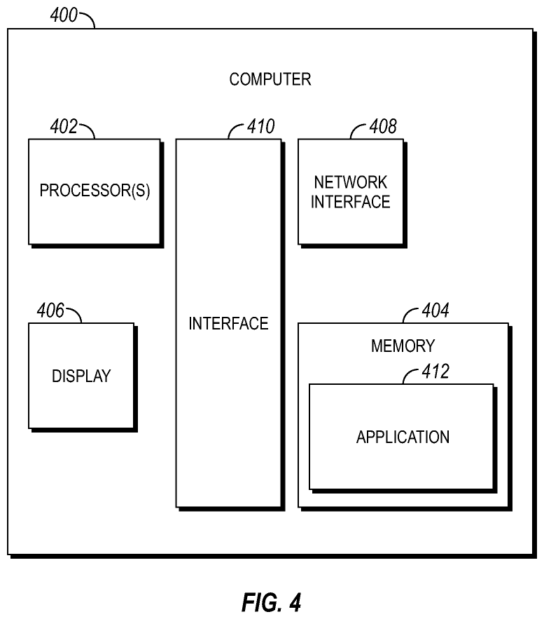

FIG. 4 depicts of a computer 400 in accordance with an embodiment of the present disclosure. Various sections of systems and computer-implemented methods described herein, may include or be executed on one or more computers similar to computer 400. The computer 400 may include various internal and external components that contribute to the function of the device and which may allow the computer 400 to function in accordance with the techniques discussed herein. It should further be noted that FIG. 4 depicts merely one example of a particular implementation and is intended to illustrate the types of components and functionalities that may be present in computer 400.

Computer 400 may include any combination of devices or software that may perform or otherwise provide for the performance of the techniques described herein. For example, computer 400 may include a tablet a smartphone, a video game device, and other hand-held networked computing devices, a desktop user device, a server, or other computing devices. Computer 400 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

In addition, the computer 400 may allow a user to connect to and communicate through a network (e.g., the Internet, a local area network, a wide area network, etc.) and may provide communication over a satellite-based positioning system (e.g., GPS). For example, the computer 400 may allow a user to communicate using e-mail, text messaging, instant messaging, or using other forms of electronic communication, and may allow a user to obtain the location of the device from the satellite-based positioning system, such as the location on an interactive map.

As shown in FIG. 4, the computer 400 may include a processor 402 (e.g., one or more processors) coupled to a memory 404, a display 406, and a network interface 408 via an interface 410. It should be appreciated the computer 400 may include other components not shown in FIG. 4, such as a power source (e.g., a battery), I/O ports, expansion card interfaces, hardware buttons, etc. In some embodiments, the display 406 may include a light emitting diode (LED) display or an organic light emitting diode (OLED) display. The display 406 may display a user interface (e.g., a graphical user interface), and may also display various function and system indicators to provide feedback to a user, such as power status, call status, memory status, etc. These indicators may be in incorporated into the user interface displayed on the display 406. In accordance with some embodiments, the display 406 may include or be provided in conjunction with touch sensitive elements through which a user may interact with the user interface. Such a touch-sensitive display may be referred to as a “touchscreen” and may also be referred to as a touch-sensitive display. In such embodiments, the display 406 may include a capacitive touchscreen, a resistive touchscreen, or any other suitable touchscreen technology.

The processor 402 may provide the processing capability required to execute the operating system, programs, user interface, and any functions of the computer 400. The processor 402 may include one or more processors that may include “general-purpose” microprocessors and special purpose microprocessors, such as one or more reduced instruction set (RISC) processors, such as those implementing the Advanced RISC Machine (ARM) instruction set. Additionally, the processor 402 may include single-core processors and multicore processors and may include graphics processors, video processors, and related chip sets. A processor may receive instructions and data from a memory (e.g., system memory 404). Processes, such as those described herein may be performed by one or more programmable processors executing computer code to perform functions by operating on input data and generating corresponding output.

The memory 404 (which may include non-transitory computer readable storage mediums) may include volatile memory and non-volatile memory accessible by the processor 402 and other components of the computer 400. The memory 404 may include volatile memory, such as random access memory (RAM), and non-volatile memory, such as ROM, flash memory, a hard drive, any other suitable optical, magnetic, or solid-state storage medium, or a combination thereof. The memory 404 may store a variety of information and may be used for a variety of purposes. For example, the memory 404 may store executable code, such as the firmware for the computer 400, an operating system for the computer 400, and any other programs. The executable computer code may include instructions executable by a processor, such as processor 402, and the computer may include instructions for implementing one or more techniques described herein with regard to various processes. For example, the memory 404 may store an application 412. For example, if the computer 400 represents a user device, the application 412 may include may enable a user to interact with an order fulfillment system of a pickup only grocery store, such as by preparing electronic shopping lists, submitting shopping carts, etc. The executable code may be written in a programming language, including compiled or interpreted languages, or declarative or procedural language, and may be composed into a unit suitable for use in a computing environment, including as a stand-alone program, a module, a component, a subroutine. Such code program may be stored in a section of a file that holds other programs or data (e.g., one or more scripts stored in a markup language document), in a single file dedicated to the program in question, or in multiple coordinated files (e.g., files that store one or more modules, sub programs, or sections of code). Additionally, the copies of the executable code may be stored in both non-volatile and volatile memories, such as in a non-volatile memory for long-term storage and a volatile memory during execution of the code.

The interface 410 may include multiple interfaces and may couple various components of the computer 400 to the processor 402 and memory 404. In some embodiments, the interface 410, the processor 402, memory 404, and one or more other components of the computer 400 may be implemented on a single chip, such as a system-on-a-chip (SOC). In other embodiments, these components, their functionalities, or both may be implemented on separate chips. The interface 410 may be configured to coordinate I/O traffic between processor 402, memory 404, network interface 406, and other internal and external components of the computer 400. The interface 410 may include functionality for interfacing via various types of peripheral buses, such as a variant of the Peripheral Component Interconnect (PCI) bus standard, the Universal Serial Bus (USB) standard, and the like.

The computer 400 depicted in FIG. 4 also includes a network interface 408, such as a wired network interface, wireless (e.g., radio frequency) receivers, etc. For example, the network interface 408 may receive and send electromagnetic signals and communicate with communications networks and other communications devices via the electromagnetic signals. The network interface 408 may include known circuitry for performing these functions, including an antenna system, an RF transceiver, one or more amplifiers, a tuner, one or more oscillators, a digital signal processor, a CODEC chipset, a subscriber identity module (SIM) card, memory, and so forth. The network interface 404 may communicate with networks, such as the Internet, an intranet, a cellular telephone network, a wireless local area network (LAN), a metropolitan area network (MAN), or other devices by wireless communication. The network interface 408 may suitable any suitable communications standard, protocol and technology, including Ethernet, Global System for Mobile Communications (GSM), Enhanced Data GSM Environment (EDGE), a 4G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), Bluetooth, Wireless Fidelity (Wi-Fi) (e.g., IEEE 402.11a, IEEE 402.11b, IEEE 402.11g or IEEE 402.11n), voice over Internet Protocol (VoIP), Wi-MAX, a protocol for email (e.g., Internet message access protocol (IMAP) or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), Multimedia Messaging Service (MMS), Short Message Service (SMS), or any other suitable communication protocol.

Those skilled in the art will also appreciate that, while various items are illustrated as being stored in memory or on storage while being used, these items or sections of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-readable medium or a portable article to be read by an appropriate drive, various examples of which are described above. In some embodiments, instructions stored on a computer-readable medium separate from computer 400 may be transmitted to computer 400 via transmission media or signals such as electrical, electromagnetic, or digital signals, conveyed via a communication medium such as a network or a wireless link Various embodiments may further include receiving, sending or storing instructions or data implemented in accordance with the foregoing description upon a computer-accessible medium. Accordingly, the present disclosure may be practiced with other computer system configurations.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A computer-implemented method, comprising:
providing in an application on a user device, by a processor, a text entry field for freeform text entry of a shopping list associated with a grocery store;
receiving, by the processor, a submission of text entered in the text entry field, the text corresponding to a one or more items of the shopping list, and a respective quantity for each of the one or more items;
processing, by the processor, the text to identify one or more specific inventory items in the grocery store that correspond to the respective one or more items of the shopping list; and
providing, in the application on the user device, by the processor, a shopping cart comprising the one or more specific inventory items, respective quantities for each or the one or more specific inventory items, and respective prices for each or the one or more specific inventory items, wherein each of the one or more inventory items replaces the respective one or more items of the shopping list.

2. The computer-implemented method of claim 1, wherein the shopping cart includes a total price comprising a sum of the respective prices for each or the one or more specific inventory.

3. The computer-implemented method of claim 1, wherein the shopping cart includes a user interface element for submission of an order based on the shopping cart.

4. The computer-implemented method of claim 3, comprising:
receiving, by the processor, a selection of the user interface element for submission of an order based on the shopping cart; and
submitting, via a network, an order to the grocery store, the order comprising the one or more inventory items.

5. The computer-implemented method of claim 1, comprising providing, in the application on the user device, by a processor, a user interface element indicating that the one or more items of the shopping list were added to the shopping cart.

6. A non-transitory computer-readable medium having executable computer code stored thereon, the executable computer code comprising instructions that, when executed, cause a processor to perform the following operations:
providing in an application on a user device, by the processor, a text entry field for freeform text entry of a shopping list associated with a grocery store;
receiving, by the processor, a submission of text entered in the text entry field, the text corresponding to a one or more items of the shopping list, and a respective quantity for each of the one or more items;
processing, by the processor, the text to identify one or more specific inventory items in the grocery store that correspond to the respective one or more items of the shopping list; and
providing, in the application on the user device, by the processor, a shopping cart comprising the one or more specific inventory items, respective quantities for each or the one or more specific inventory items, and respective prices for each or the one or more specific inventory items,
wherein each of the one or more inventory items replaces the respective one or more items of the shopping list.

7. The non-transitory computer-readable medium of claim 6, wherein the shopping cart includes a total price comprising a sum of the respective prices for each or the one or more specific inventory.

8. The non-transitory computer-readable medium of claim 6, wherein the shopping cart includes a user interface element for submission of an order based on the shopping cart.

9. The non-transitory computer-readable medium of claim 8, the operations comprising:
receiving, by the processor, a selection of the user interface element for submission of an order based on the shopping cart; and
submitting, via a network, an order to the grocery store, the order comprising the one or more inventory items.

10. The non-transitory computer-readable medium of claim 6, the operations comprising providing, in the application on the user device, by a processor, a user interface element indicating that the one or more items of the shopping list were added to the shopping cart.

11. A system, comprising:
a processor;
a non-transitory computer-readable memory communicatively coupled to the processor, the non-transitory computer-readable memory having executable computer code stored thereon, the executable computer code comprising instructions that, when executed, cause one or more processors to perform the following operations:
providing in an application on a user device, by the processor, a text entry field for freeform text entry of a shopping list associated with a grocery store;
receiving, by the processor, a submission of text entered in the text entry field, the text corresponding to a one or more items of the shopping list, and a respective quantity for each of the one or more items;
processing, by the processor, the text to identify one or more specific inventory items in the grocery store that correspond to the respective one or more items of the shopping list; and
providing, in the application on the user device, by the processor, a shopping cart comprising the one or more specific inventory items, respective quantities for each or the one or more specific inventory items, and respective prices for each or the one or more specific inventory items, wherein each of the one or more inventory items replaces the respective one or more items of the shopping list.

12. The system of claim 11, wherein the shopping cart includes a total price comprising a sum of the respective prices for each or the one or more specific inventory.

13. The system of claim 11, wherein the shopping cart includes a user interface element for submission of an order based on the shopping cart.

14. The system of claim 13, the operations comprising:
receiving, by the processor, a selection of the user interface element for submission of an order based on the shopping cart; and
submitting, via a network, an order to the grocery store, the order comprising the one or more inventory items.

15. The system of claim 11, the operations comprising providing, in the application on the user device, by a processor, a user interface element indicating that the one or more items of the shopping list were added to the shopping cart.
